(19) United States
(12) Patent Application Publication
(10) Pub. No.: US 2023/0285789 A1
(43) Pub. Date: Sep. 14, 2023

(54) FOAM FIRE EXTINGUISHING AGENT

(71) Applicant: YAMATO PROTEC CORPORATION, Tokyo (JP)

(72) Inventors: Wataru Kobayashi, Inashiki-gun (JP); Yuki Takatsuka, Inashiki-gun (JP); Shogo Tomiyama, Inashiki-gun (JP)

(73) Assignee: YAMATO PROTEC CORPORATION, Tokyo (JP)

(21) Appl. No.: 18/010,291

(22) PCT Filed: Jun. 11, 2021
(86) PCT No.: PCT/JP2021/022377

§ 371 Date: Dec. 14, 2022

(30) Foreign Application Priority Data
Jun. 22, 2020 (JP) 2020-106735

(51) Int. Cl. A62D 1/02

(52) U.S. Cl. CPC A62D 1/0071

(57) ABSTRACT

An object of the present invention is to provide a foam fire extinguishing agent that does not contain a fluorine compound and can satisfy predetermined performance. The foam fire extinguishing agent in accordance with the present invention is characterized by comprising 0.1 to 2% by mass of a phosphorus-containing compound, and 1 to 10% by mass of a cationic polymer.

### TECHNICAL FIELD

The present invention relates to a foam fire extinguishing agent, and particularly to a fluorine-free foam fire extinguishing agent that does not contain a fluorine-based compound and has excellent heat resistance.

### PRIOR ARTS

Foam fire extinguishing agents are mainly used for fires of flammable liquids belonging to the fourth class of dangerous substances and are supplied in a foamed state. The supplied foam is rapidly spread on the flammable liquid to extinguish fire.

In order to extinguish fire rapidly, it is required that the foam fire extinguishing agent has excellent heat resistance, and in addition, various performances as fire extinguishing agents are required, such as satisfying predetermined foaming performance, not dissolving in the flammable dangerous substance, and preventing components from separating or precipitating over a long period of time. Therefore, there is a problem that the foam fire extinguishing agent needs to satisfy these various performances in a well-balanced manner while increasing heat resistance.

In order to satisfy such a demand, as conventional foam fire extinguishing agents, a surfactant containing a fluorine-based compound is used as one of the components as proposed in, for example, Patent Literature 1 (JP 2007-252731 A) ((Patent Literature 1).

### CITATION LIST

### Patent Literature

Patent Literature 1: JP 2007-252731 A

### SUMMARY OF INVENTION

### Technical Problem

However, in recent years, due to the influence of Stockholm Convention on Persistent Organic Pollutants (POPs Convention), there has been a movement to regulate the production and use of organic fluorine compounds such as perfluorooctanesulfonic acid (PFOS), perfluorooctanoic acid (PFOA) and perfluorohexanesulfonic acid (PFHxS) and related substances thereof.

Accordingly, an object of the present invention is to provide a foam fire extinguishing agent that does not contain a fluorine compound and can satisfy predetermined performance.

### Solution to Problem

In order to solve the above problems, the present inventors have conducted intensive studies and have found that a fire extinguishing agent containing a non-fluorine-based cationic polymer and a non-fluorine-based phosphorus-containing compound in respective predetermined amounts satisfies the performance as a foam fire extinguishing agent even without containing a fluorine compound and has excellent heat resistance, and have completed the present invention.

Namely, the foam fire extinguishing agent of the present invention is characterized by containing
0.1 to 2% by mass of a phosphorus-containing compound, and
1 to 10 by mass of a cationic polymer.

In the foam fire extinguishing agent of the present invention, the phosphorus-containing compound is preferably at least one of trimethyl phosphate, triethyl phosphate, triphenyl phosphate, tricresidyl phosphate, trixylenyl phosphate, naphthyl diphenyl phosphate, dinaphthyl phenyl phosphate, tricresyl phosphate, cresyl phenyl phosphate cresyl 2,6-xylenyl phosphate, tributoxyethyl phosphate, 2-ethylhexyl diphenyl phosphate, 1,3-phenylene bis(diphenyl phosphate), 1,3-phenylene bis(di2,6-xylenyl phosphate), bisphenol A bis(diphenyl phosphate), resorcinol bisdiphenyl phosphate, hydroquinone bis(bis(2,6-dimethylphenyl)phosphate), biphenol bis(bis(2,6-dimethylphenyl)phosphate), octyl diphenyl phosphate, diethylene ethyl ester phosphate, dihydroxypropylene butyl ester phosphate, ethylene disodium ester phosphate, t-butylphenyl diphenyl phosphate, bis-(t-butylphenyl) phenyl phosphate, tris-(t-butylphenyn phenyl phosphate, isopropylphenyl diphenyl phosphate, bis-(isopropylphenyl) diphenyl phosphate, tris-(isopropylphenyl) phosphate, tris(2-ethylhexyl) phosphate, tris(butoxyethyl) phosphate, trisisobutyl phosphate, methylphosphonic acid, dimethyl methylphosphonate, diethyl methylphosphonate, ethylphosphonic acid, propylphosphonic acid, butylphosphonic acid, 2-methyl-propylphosphonic acid, t-butylphosphonic acid, 2,3-dimethylbutylphosphonic acid, octylphosphonic acid, phenylphosphonic acid, diethylphosphinic acid, methylethylphosphinic acid, methylpropylphosphinic acid, diethylphosphinic acid, dioctylphosphinic acid, phenylphosphinic acid, diethylphenylphosphinic acid, diphenylphosphinic acid, and alkylphosphate esters, and condensates containing these structures.

In the foam fire extinguishing agent of the present invention, the cationic polymer is preferably at least one of a copolymer of (meth)acrylaminoethyltrimethylammonium including a copolymer of (meth)acrylic acid ester and (meth)acrylaminoethyltrimethylammonium, a copolymer of (meth acrylamide and (meth)acrylaminoethyltrimethylammonium, a copolymer of (meth)acrylaminodialkyl and (meth)acrylaminoethyltrimethylammonium, poly(meth)acrylaminoethyltrimethylammonium; a dicyandiamide-based condensate including a condensate of dicyandiamide and formaldehyde, a condensate of dicyandiamide and diethylenetriamine, a condensate of dialkylamine and epihalohydrin including dimethylamine-epichlorohydrin condensate, a condensate of diethylamine, epichlorohydrin, a condensate of dimethylamine, epichlorohydrin and ammonia, a condensate of diethylamine, epichlorohydrin and ammonia; a copolymer of diallyldimethylammonium chloride including polydiallyldimethylammonium chloride, a copolymer of diallyldimethylammonium chloride and acrylamide, a copolymer of diallyldimethylammonium chloride and sulfur dioxide, a copolymer of diallyldimethylammonium chloride and (meth)acrylamide, a copolymer of diallyldimethylammonium chloride and (meth)acrylic acid, a copolymer of diallyldimethylammonium chloride, (meth)acrylic acid and (meth)acrylamide; and polyalkylamine including polyethyleneimine, polyallylamine, polyvinylamine.

### Effect of the Invention

In accordance with the present invention, it is possible to provide a foam fire extinguishing agent that does not contain a fluorine compound and satisfies predetermined performance, and is particularly excellent in heat resistance.

### EMBODIMENTS FOR ACHIEVING THE INVENTION

Hereinafter, the foam fire extinguishing agent in accordance with a representative embodiment of the present invention will be described in detail with reference to the Table. However, the present invention is not limited to these examples.

The foam fire extinguishing agent in accordance with the present embodiment contains 0.1 to 2% by mass of the phosphorus-containing compound, 1 to 10% by mass of the cationic polymer, 1 to 10% by mass of a carbitol-based organic solvent, and 1 to 10% by mass of a surfactant, and the balance is mainly water and 100% by mass in total (all of the balance may be water). In such a formulation, excellent heat resistance and other performances (e.g., foaming performance and foam durability) can be achieved while containing no fluorine compound. As a factor that the favorable result is obtained by the above-described blending, the present inventors have presumed that heat resistance is improved by forming a complex from the combined raw materials.

Further, it is preferable that the foam fire extinguishing agent of the present invention contains 0.1 to 2% by mass of the phosphorous-containing compound and 1 to 10% by mass of the cationic polymer.

Examples of the phosphorus-containing compound may be at least one of trimethyl phosphate, triethyl phosphate, triphenyl phosphate, tricresidyl phosphate, trixylenyl phosphate, naphthyl diphenyl phosphate, dinaphthyl phenyl phosphate, tricresyl phosphate, cresyl phenyl phosphate, cresyl 2,6-xylenyl phosphate, tributoxyethyl phosphate, 2-ethylhexyl diphenyl phosphate, 1,3-phenylene bis(diphenyl phosphate), 1,3-phenylene bis(di2,6-xylenyl phosphate), bisphenol A bis(diphenyl phosphate), resorcinol bisdiphenyl phosphate, hydroquinone bis(bis(2,6-dimethylphenyl) phosphate), biphenol bis(bis(2,6-dimethylphenyl) phosphate), octyl diphenyl phosphate, diethylene ethyl ester phosphate, dihydroxypropylene butyl ester phosphate, ethylene disodium ester phosphate, t-butylphenyl diphenyl phosphate, bis-(t-butylphenyl) phenyl phosphate, tris-(t-butylphenyl) phenyl phosphate, isopropylphenyl diphenyl phosphate, bis-(isopropylphenyl) diphenyl phosphate, tris-(isopropylphenyl) phosphate, tris(2-ethylhexyl) phosphate, tris(butoxyethyl) phosphate, trisisobutyl phosphate, methylphosphonic acid, dimethyl methylphosphonate, diethyl methylphosphonate, ethylphosphonic acid, propylphosphonic acid, butylphosphonic acid, 2-methyl-propylphosphonic acid, t-butylphosphonic acid, 2,3-dimethylbutylphosphonic acid, octylphosphonic acid, phenylphosphonic acid, diethylphosphinic acid, methylethylphosphinic acid, methylpropylphosphinic acid, diethylphosphinic acid, dioctylphosphinic acid, phenylphosphinic acid, diethylphenylphosphinic acid, diphenylphosphinic acid, and alkylphosphate esters, and condensates containing these structures.

As the phosphorus-containing compound, it is preferable to use resorcinol bisdiphenyl phosphate in consideration of solubility in water, availability of raw material, and compatibility with other raw materials.

Further, the cationic polymer may include various cationic polymers, and examples thereof may be at least one of a copolymer of (meth)acrylaminoethyltrimethylammonium including a copolymer of (meth)acrylic acid ester and (meth)acrylaminoethyltrimethylammonium, a copolymer of (meth)acrylamide and (meth)acrylaminoethyltrimethylammonium, a copolymer of (meth)acrylaminodialkyl and (meth)acrylaminoethyltrimethylammonium, poly(meth)acrylaminoethyltrimethylammonium; a dicyandiamide-based condensate including a condensate of dicyandiamide and formaldehyde, a condensate of dicyandiamide and diethylenetriamine, a condensate of dialkylamine and epihalohydrin including dimethylamine-epichlorohydrin condensate, a condensate of diethylamine, epichlorohydrin, a condensate of dimethylamine, epichlorohydrin and ammonia, a condensate of diethylamine, epichlorohydrin and ammonia; a copolymer of diallyldimethylammonium chloride including polydiallyldimethylammonium chloride, a copolymer of diallyldimethylammonium chloride and acrylamide, a copolymer of diallyldimethylammonium chloride and sulfur dioxide, a copolymer of diallyldimethylammonium chloride and (meth)acrylamide, a copolymer of diallyldimethylammonium chloride and (meth)acrylic acid, a copolymer of diallyldimethylammonium chloride, (meth)acrylic acid and (meth)acrylamide; and polyalkylamine including polyethyleneimine, polyallylamine, polyvinylamine.

As the cationic polymer, polyethyleneimine, or polyallylamine is preferable in consideration of solubility in water, availability of raw material, and compatibility with other raw materials.

In accordance with the experimental results by the present inventors, the most preferable combination is resorcinol bisdiphenyl phosphate as the phosphorus-containing compound and polyethyleneimine as the cationic polymer.

Here, with respect to the lower limits of the contents of the cationic polymer and the phosphorus-containing compound, when the cationic polymer is less than 1% by mass, there is a disadvantage that the foam disappearance time is shortened and required performance cannot be obtained, and when the phosphorus-containing compound is less than 0.1% by mass, there is a disadvantage that sufficient heat resistance performance cannot be obtained.

In addition, with respect to the upper limits of the contents of the cationic polymer and the phosphorus-containing compound, when the cationic polymer exceeds 10% by mass, there is a disadvantage that the foam disappearance time is shortened and the required performance cannot be obtained, and when the phosphorus-containing compound exceeds 2% by mass, there is a disadvantage that the solution is separated and a foam fire extinguishing agent cannot be formed.

As described above, despite the formulation that does not contain a fluorine-based compound, the foam fire extinguishing agent of the present embodiment has excellent heat resistance and other performances that have been difficult to achieve in the past. Further, the raw materials are excellent in availability.

### EXAMPLE

10% by mass of butyl carbitol, 10% by mass of a surfactant, and polyethyleneimine as the cationic polymer and resorcinol bisdiphenyl phosphate as the phosphorus-containing compound in the contents shown in Table 1 were mixed to obtain a mixture, and water was added (measured up) to the mixture to prepare 25 foam fire extinguishing agent samples (foam aqueous solutions) of a total of 100% by mass, and the samples were subjected to the following heat resistance test.

Butyl carbitol is a solvent also blended in an actual fire extinguishing agent. Further, in addition to an organic solvent such as a carbitol, a surfactant, and water, ingredients such as ethylene glycol may be added to the actual fire extinguishing agent.

### Heat Resistance Test

A heat resistance test, was performed in accordance with the following procedure by using each foam fire extinguishing agent sample.
(1) n-Heptane was put into a round dish having a diameter of 11 cm (95 cm²) and ignited.
(2) The foam fire extinguishing agent foamed with a jouser mixer was taken up with a spoon and put into the round dish after 1 minute from the ignition.
(3) The foam agent was continuously added until the fire was extinguished.
(4) After extinguishing the fire, the foam at the center of the round dish was removed to expose an oil surface of about φ3 cm (7 cm²).
(5) The exposed oil surface was ignited again.
(6) The area of the oil surface after 5 minutes from the ignition or the time for all foam to disappear was measured.

In the above-described heat resistance test, the success or failure was determined, and the state of the solution was observed. The criteria for determining the success or failure were as follows:
A case where the oil surface area after 5 minutes from the ignition was 50 cm² or less was defined as ◯;
A case where the oil surface area after 5 minutes from the ignition was 30 cm² or less was defined as ⊚;
A case where the foam remained on the oil surface after 5 minutes from the ignition was defined as Δ;
A case where foam disappeared or the solution was separated not to be evaluated within 5 minutes after the ignition was defined as x.
   When the evaluation is ⊚, ◯, or Δ the heat resistance is practically acceptable, and when being or ⊚ or ◯, the heat resistance is particularly preferable. The results are shown in Table 1.

TABLE 1

| | | Phosphorous | | | | | |
|---|---|---|---|---|---|---|---|
| | | containing | | | | | |
| | | compound | | | | | |
| | Cationic | (Resorcinol | | Oil surface | | Foam | |
| | polymer | bisdiphenyl | State of | area after | | disappearance | |
| No | (Polyethyleneimine) | phosphate) | solution | 5 min. | | time | Evaluation |
| 1 | 0% | 0% | Good | — | | 1 min 12 sec | × |
| 2 | 0% | 0.1% | Separated | — | | — | × |
| 3 | 0% | 0.5% | Separated | — | | — | × |
| 4 | 0% | 1% | Separated | — | | — | × |
| 5 | 0% | 2% | Separated | — | | — | × |
| 6 | 0% | 3% | Separated | — | | — | × |
| 7 | 1% | 0% | Good | — | | 4 min 22 sec | × |
| 8 | 1% | 0.1% | Good | 72.3 | cm² | — | Δ |
| 9 | 1% | 0.5% | Good | 69.3 | cm³ | — | Δ |
| 10 | 1% | 1% | Good | 63.5 | cm² | — | Δ |
| 11 | 1% | 2% | Good | 56.7 | cm² | — | Δ |
| 12 | 1% | 3% | Separated | — | | — | × |
| 13 | 5% | 0% | Good | — | | 3 min 21 sec | × |
| 14 | 5% | 0.1% | Good | 78.5 | cm² | — | Δ |
| 15 | 5% | 0.5% | Good | 50.2 | cm² | — | Δ |
| 16 | 5% | 1% | Good | 9.6 | cm² | — | ⊚ |
| 17 | 5% | 2% | Good | 1.8 | cm² | — | ⊚ |
| 18 | 5% | 3% | Separated | — | | — | × |
| 19 | 10% | 0% | Good | — | | 4 min 2 sec | × |
| 20 | 10% | 0.1% | Good | 63.5 | cm² | — | Δ |
| 21 | 10% | 0.5% | Good | 49.6 | cm² | — | ◯ |
| 22 | 10% | 1% | Good | 3.1 | cm² | — | ⊚ |
| 23 | 10% | 2% | Good | 38.5 | cm² | — | ◯ |

| | | | | | | |
|---|---|---|---|---|---|---|
| 24 | 10% | 3% | Separated | — | — | × |
| 25 | 15% | 0% | Good | — | 3 min 37 sec | × |
| 26 | 15% | 0.1% | Good | — | 1 min 58 sec | × |
| 27 | 15% | 0.5% | Good | — | 2 min 4 sec | × |
| 28 | 15% | 1% | Good | — | 1 min 46 sec | × |
| 29 | 15% | 2% | Good | — | 2 min 25 sec | × |
| 30 | 15% | 3% | Good | — | 2 min 45 sec | × |

From the results shown in Table 1, it is found that when the foam fire extinguishing agent in accordance with the present invention contains 1 to 2% by mass of the phosphorus-containing compound and 1 to 10% by mass of the cationic polymer, the agent is excellent in heat resistance and can suitably exhibit the fire extinguishing function. Further, it is found that when the foam fire extinguishing agent in accordance with the present invention contains 1 to 2% by mass of the phosphorus-containing compound and 5 to 10% by mass of the cationic polymer, the agent is further excellent.

1. A foam fire extinguishing agent, characterized by comprising 0.1 to 2% by mass of a phosphorus-containing compound, and 1 to 10 by mass of a cationic polymer.

2. The foam fire extinguishing agent in accordance with claim 1, wherein the phosphorus-containing compound is at least one of trimethyl phosphate, triethyl phosphate, triphenyl phosphate, tricresidyl phosphate, trixylenyl phosphate, naphthyl diphenyl phosphate, dinaphthyl phenyl phosphate, tricresyl phosphate, cresyl phenyl phosphate, cresyl 2,6-xylenyl phosphate, tributoxyethyl phosphate, 2-ethylhexyl diphenyl phosphate, 1,3-phenylene bis(diphenyl phosphate), 1,3-phenylene bis(di2,6-xylenyl phosphate), bisphenol A bis(diphenyl phosphate), resorcinol bisdiphenyl phosphate, hydroquinone bis(bis(2,6-dimethylphenyl) phosphate), biphenol bis(bis(2,6-dimethylphenyl) phosphate), octyl diphenyl phosphate, diethylene ethyl ester phosphate, dihydroxypropylene butyl ester phosphate, ethylene disodium ester phosphate, t-butylphenyl diphenyl phosphate, bis-(t-butylphenyl) phenyl phosphate, tris-(t-butylphenyl)) phenyl phosphate, isopropylphenyl diphenyl phosphate, bis-(isopropylphenyl) diphenyl phosphate, tris-(isopropylphenyl) phosphate, tris(2-ethylhexyl) phosphate, tris(butoxyethyl) phosphate, trisisobutyl phosphate, methylphosphonic acid, dimethyl methylphosphonate, diethyl methylphosphonate, ethylphosphonic acid, propylphosphonic acid, butylphosphonic acid, 2-methyl-propylphosphonic acid, t-butylphosphonic acid, 2,3-dimethylbutylphosphonic acid, octylphosphonic acid, phenylphosphonic acid, diethylphosphinic acid, methylethylphosphinic acid, methylpropylphosphinic acid, diethylphosphinic acid, dioctylphosphinic acid, phenylphosphinic acid, diethylphenylphosphinic acid, diphenylphosphinic acid, and alkylphosphate esters, and condensates containing these structures.

3. The foam fire extinguishing agent in accordance with claim 1, wherein the cationic polymer is at least one of a copolymer of (meth)acrylaminoethyltrimethylammonium including a copolymer of (meth)acrylic acid ester and (meth)acrylaminoethyltrimethylammonium, a copolymer of (meth)acrylamide and (meth)acrylaminoethyltrimethylammonium, a copolymer of (meth)acrylaminodialkyl and (meth)acrylaminoethyltrimethylammonium, poly(meth)acrylaminoethyltrimethylammonium; a dicyandiamide-based condensate including a condensate of dicyandiamide and formaldehyde, a condensate of dicyandiamide and diethylenetriamine, a condensate of dialkylamine and epihalohydrin including dimethylamine-epichlorohydrin condensate, a condensate of diethylamine, epichlorohydrin, a condensate of dimethylamine, epichlorohydrin and ammonia, a condensate of diethylamine, epichlorohydrin and ammonia; a copolymer of diallyldimethylammonium chloride including polydiallyldimethylammonium chloride, a copolymer of diallyldimethylammonium chloride and acrylamide, a copolymer of diallyldimethylammonium chloride and sulfur dioxide, a copolymer of diallyldimethylammonium chloride and (meth)acrylamide, a copolymer of diallyldimethylammonium chloride and (meth)acrylic acid, a copolymer of diallyldimethylammonium chloride, (meth)acrylic acid and (meth)acrylamide; and polyalkylamine including polyethyleneimine, polyallylamine, polyvinylamine.
